(19) United States
(12) Patent Application Publication
(10) Pub. No.: US 2015/0125579 A1
(43) Pub. Date: May 7, 2015

(54) METHOD AND DEVICE FOR PACKAGING READY MEALS IN AT LEAST ONE BOWL

(71) Applicant: Karl-Wilhelm SCHRADE, Zetel (DE)

(72) Inventor: Karl-Wilhelm SCHRADE, Zetel (DE)

(21) Appl. No.: 14/534,799

(22) Filed: Nov. 6, 2014

(30) Foreign Application Priority Data
Nov. 6, 2013 (DE) 10 2013 018 629.3

(51) Int. Cl. A23L 3/3418; B65B 31/04; A23L 1/025; B65B 7/28

(52) U.S. Cl. CPC A23L 3/3418; B65B 7/2842; B65B 31/043; A23L 1/0255; A23V 2002/00
USPC 426/234; 53/329; 53/510; 426/392

(57) ABSTRACT

For packaging ready meals in at least one bowl featuring a circumferential rim, where the basic ingredients of the meal are placed into the bowl, a cover foil is sealed to the circumferential rim of the bowl so as to leave at least two rim sections unsealed, where the meal is subsequently prepared in the bowl, after which the cover foil is sealed completely over the whole circumferential rim of the bowl. A device for packaging ready meals in at least one bowl with circumferential rim, includes a sealing tool for complete sealing of a cover foil to the circumferential rim. The sealing tool or a second sealing tool is provided for partial sealing of the cover foil to the circumferential rim.

### BACKGROUND OF THE INVENTION

1. Field of the Invention

The invention relates to a method for packaging ready meals in at least one bowl featuring a circumferential rim, into which the basic ingredients of the ready meal are placed. The invention also concerns a device for packaging ready meals in at least one bowl with circumferential rim, consisting of a sealing tool for completely sealing a cover foil to the circumferential rim of the bowl.

2. Brief Discussion of the Related Art

With the method for ready meals known from prior art, the basic ingredients are processed inside the bowl. For this purpose, the bowl containing the ingredients is transferred for preparation in open form. In this way, attention can be paid to the special consistencies of the separate ingredients and a selective way of preparation is possible.

After preparation, e.g. by heating, the open bowl will be sealed, which has the disadvantage that the heated and thus partially pasteurised ingredients will be exposed to a foil introduced from outside that may carry germs and impurities.

Suggestions have already been made in prior art for the basic ingredients to be sealed in the bowl prior to processing, i.e. to seal the bowl completely with cover foil. During subsequent heating of the ingredients, these are cooked, e.g. by steam generated in a microwave oven. However, the result is that in the case of a menu with several different types of basic ingredients all the components are subjected to identical heat energy. The cooking requirements of separate ingredients cannot be taken into account.

With this familiar generic method, the work is done as in a steam cooker on a single level. Vegetables and salmon are, for instance, subjected to the same temperature for the same cooking time, with the result that, due to the longer cooking needed for salmon, the vegetables are usually overcooked.

### SUMMARY OF THE INVENTION

The object of the invention is to develop a method of the type mentioned in the beginning that facilitates a high-quality preparation of ready meals whilst simultaneously reducing the exposure to germs. Furthermore, a device for packaging is to be presented, preferably for accomplishing said method.

With regard to the method, the said object is achieved with the invention by sealing a cover foil to the circumferential rim of the bowl so that there are at least two unsealed sections along the rim, with the meal subsequently being prepared in the bowl and thereafter the foil is completely sealed to the circumferential rim in a second sealing process.

The invention-based method facilitates selective processing of the basic ingredients similar to the open-bowl method. The various ingredients can each be subjected to different cooking energies; excess heat can escape from the bowl, as the cover foil is not fully sealed to the circumferential rim of the bowl. At least two unsealed rim sections are left.

The cover foil is consequently no hindrance to a qualitative processing of the ingredients. On the other hand, a cover foil is in place while the ingredients are cooking, so that the application of heat leads to a substantial sterilisation of the cover foil. When the basic ingredients are fully cooked, the invention provides for the bowl to be completely sealed in a second sealing process using the same foil. No new foil is introduced to the bowl at this point; instead the already partially sealed foil in place during the heating process is now fully attached to the circumferential rim, so that the package is completely sealed.

A further development of the invention-based method provides that, prior to the second sealing of the cover foil, free ends of gas hoses are placed close to the unsealed rim sections. This allows e.g. for the bowl to be filled with protective gas via said conduits. A vacuum may also be applied to said gas hoses to extract air from the bowl. The oxygen content of the exhausted gas can be measured, e.g. when air is to be replaced by a protective gas such as nitrogen.

The ready meal may be prepared, as in the state of the art, by microwaves; the cover foil will be sterilised by the heat generated in the process.

A predefined quantity of cold-filtered air or gas can be pressed into the bowl via a gas line. Another gas line will simultaneously siphon off the atmosphere from the bowl. The feed hose can then be closed and atmosphere can be extracted from the bowl until the oxygen content approximates 0%. A pre-determinable vacuum is thus drawn with the exchange of air; alternatively, a pre-determinable quantity of nitrogen can be introduced. This may also suck in the cover foil.

The device intended for achieving the objective is distinguished by the fact that the existing sealing tool or a second sealing tool is designated to seal the cover foil to the circumferential rim only partially.

The invention-based device is a state of the art sealing tool that can be used for fully sealing a cover foil to the circumferential rim of the bowl. According to the invention, said sealing tool or, if necessary, a second sealing tool is provided to facilitate partial sealing of the cover foil along the rim. This method makes available the unsealed rim sections intended by the invention, and gases may be introduced or extracted through these sections.

The sealing tool for partial sealing may for example reconstruct the circumferential rim of the bowl incompletely so that at least two sections of the circumferential rim have no equivalent section on the sealing tool to cover them. During subsequent complete sealing, all the parts of the circumferential rim have corresponding parts of the sealing tool assigned.

Gas hoses can be assigned to the unsealed sections of the circumferential rim, with the free ends of said hoses facing the unsealed sections. One gas hose may feature an oxygen content sensor.

### BRIEF DESCRIPTION OF THE DRAWINGS

One exemplary embodiment of the invention that gives rise to further characteristics of the invention is represented in the drawings. They show the following:

FIG. 1 shows a perspective view of a bowl used for the invention-based method and

FIG. 2 shows a lateral view of the bowl according to FIG. 1

### DETAILED DESCRIPTION OF THE PREFERRED EMBODIMENTS

With the invention-based method for packaging ready meals, the basic ingredients, e.g. potatoes, vegetables or meat, are placed in a bowl 1. Said bowl 1 has a bowl base and bowl sides, the latter featuring a circumferential rim 2 around the top edge.

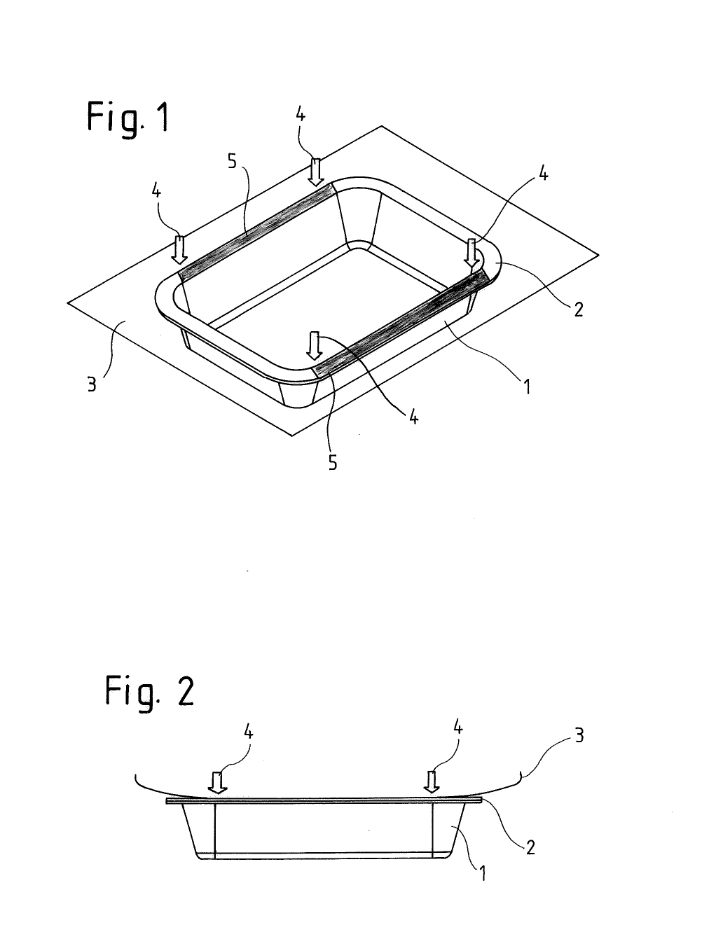

FIG. 1 shows a cover foil 3 being placed on the circumferential rim 2. In FIG. 1 said cover foil 3, as indicated by arrows 4, are sealed to the longer sections of the circumferential rim 2. The sealing between cover foil 3 and circumferential rim 2 is thus in the region of the dark sections 5. The shorter sections of the circumferential rim 2 in the area of the front faces of bowl 1 remain unsealed.

FIG. 1 thus shows the state at which the ingredients that have been placed in the bowl can be processed. An atmosphere may develop within the bowl 1, but steam pressure is largely avoided.

FIG. 2 likewise shows the pre-sealed state of bowl 1 with cover foil 3. In the unsealed region of the circumferential rim 2, the cover foil 3 detaches from the rim, thereby facilitating pressure reduction inside the bowl 1 over said unsealed areas of the circumferential rim 2. Similarly, gas hoses, not shown here, can be used to feed protective gas or extract air via said unsealed regions of the rim 2.

After the ingredients inside bowl 1 have been fully processed, a second sealing process causes the cover foil 3 to be completely sealed to the circumferential rim 2. Sections 5 are re-sealed but this does not affect their function. The previously unsealed sections of the circumferential rim 2 are sealed for the first time with the cover foil 3, which can then be trimmed along the edge of the circumferential rim 2.

All the features mentioned in the afore-going description and in the claims can be combined in any desired way with the characteristics of the independent claim. The disclosure of the invention is therefore not restricted to the combination of the characteristics described and claimed, instead any sensible combination of characteristics within the scope of the invention are to be regarded as disclosed.

1. A method for packaging ready meals in at least one bowl featuring a circumferential rim, where the basic ingredients of the meal are placed into the bowl, wherein
a cover foil is sealed to the circumferential rim of a bowl, leaving at least two unsealed rim sections, with the meal being subsequently prepared in the bowl, after which the cover foil is resealed to the whole of the circumferential rim of the bowl in a second sealing process.

2. A method according to claim 1, wherein, prior to the second sealing of the cover foil, free ends of gas hoses are placed near the unsealed rim sections.

3. A method according to claim 1, wherein the ready meal is prepared by microwaves.

4. A device for packaging ready meals in at least one bowl with circumferential rim, comprising a sealing tool for completely sealing a cover foil to the circumferential rim, wherein
said sealing tool or a second sealing tool is provided for partially sealing the cover foil to the circumferential rim.

5. A device according to claim 4 wherein the sealing tool for partial sealing reconstructs the circumferential rim of the bowl incompletely in that at least two sections of the circumferential rim have no counterpart in the sealing tool.

6. A device according to claim 5 wherein free ends of gas hoses are placed near the unsealed sections of the circumferential rim.

7. A device according to claim 6 wherein an oxygen content sensor is assigned to at least one gas hose.
